(19) United States
(12) Patent Application Publication
(10) Pub. No.: US 2008/0276486 A1
(43) Pub. Date: Nov. 13, 2008

(54) Domestic appliance with a cooling apparatus

(76) Inventors: Heinz-Dieter Eichholz, Iserlohn (DE); Georg Pfitzer, Weingarten (DE); Bernd Geser, Wasserburg (DE)

Correspondence Address: WILLIAM D. BRENEMAN, ESQ.;BRENEMAN & GEORGES, 3150 COMMONWEALTH AVENUE, ALEXANDRIA, VA, 22305, US

(21) Appl. No.: 12/149,942

(22) Filed: May 9, 2008

(30) Foreign Application Priority Data
May 11, 2007 (DE) 10 2007 022 697.9
Oct. 11, 2007 (DE) 10 2007 049 054.4

(51) Int. Cl. F26B 3/02; F25B 15/00; B08B 3/04; D06F 37/00; B01F 3/04

(52) U.S. Cl. 34/513; 62/476; 134/58 D; 68/5 C; 99/323.1

(57) ABSTRACT

The invention proposes a domestic appliance having a cooling unit which provides an extended range of ways of utilizing the heat provided for the cooling unit as process heat during working operation of the domestic appliance. According to the invention, this is achieved by using a liquid sorbent and/or a liquid sorbent/refrigerant mixture.

The invention relates to a domestic appliance having a cooling apparatus according to the preamble of Claim 1. In many domestic appliances such as dishwashers, tumble dryers or the like, a cooling process is often advantageous, at least as a subprogram step, in addition to other operating processes.

For example, in beverage machines such as espresso machines or the like, it may be expedient to cool a hot beverage in order to provide a beverage which has been prepared hot as a cold beverage, for example as iced coffee.

Cooling units are also advantageous for drying processes since moisture from the air can be condensed by the said cooling units. In a tumble dryer, the entire operating process is, for example, a drying process, but in a machine such as a dishwasher or a washing machine with an integrated drying system, drying is generally provided as a subprogram step at the end of a program sequence.

Various options have been disclosed for drying, in particular, washware in a dishwasher.

For example, the washware can be dried by its inherent heat when the washware is washed at such a high temperature in the last wash cycle, generally a final-rinse cycle, that the washware subsequently dries quickly on its own.

On account of the large amount of heat transferred to the washware, the residual water remaining on the washware after the wash cycle evaporates and condenses on colder surfaces and/or is actively expelled from the dishwasher.

In addition, separate heating apparatuses for drying purposes, for example in the form of hot-air fans or the like, are known for heating the air mixture provided for drying purposes and therefore increasing the moisture-absorption capacity of the said air mixture.

In all these cases, a high energy requirement is associated with drying.

In order to reduce the energy consumption by the drying process, WO 2005/053503 A1 has furthermore proposed a dishwasher in which drying is effected by the moist air from the working chamber of the dishwasher being condensed on a cold condensation surface, so that the water which is produced as condensate can be discharged. In this case, the condensation surface is cooled by an inherently closed apparatus using the cold of evaporation of water. In an evaporator, water is evaporated as refrigerant, as a result of which the surface of the evaporator cools down, so that water from an air stream which is passing by can condense on the said surface. Evaporation of the water is achieved by the connection of the evaporator to an attached sorption container which contains a sorbent which adsorbs the evaporated refrigerant. In particular, the cited prior document proposes the use of zeolite as the sorbent.

The described prior art also provides for the thermal energy used for desorption to be used to heat the washing liquor and/or the dishes with the aid of an air stream which can be heated on the sorbent.

On account of the use of a solid adsorber, as is described in this document, structural limits are placed on the manner of heat supply for desorption of the water used as refrigerant and the manner of heat dissipation for use of the heat of desorption in this prior art.

The object of the invention is therefore to propose a domestic appliance having a cooling unit, for example for drying wet, cleaned articles by means of condensation, which provides an extended range of ways of utilizing the heat provided for the cooling unit as process heat during working operation of the domestic appliance.

Taking a domestic appliance according to the preamble of the claim as a starting point, this object is achieved by the characterizing features of the said claim.

Advantageous embodiments and developments of the invention are possible by virtue of the measures cited in the subclaims.

A domestic appliance according to the invention is accordingly distinguished in that a liquid sorbent and/or a liquid sorbent/refrigerant mixture are/is provided.

A significantly wider variety of structures and methods are provided for supplying heat or utilizing the waste heat on account of the liquid property. For example, heat can be supplied to the sorbent or to the sorbent/refrigerant mixture in an area of restricted space within the sorption container, it being possible to achieve uniform heat distribution by recirculation, that is to say by active recirculation using pumping or stirring means or else by passive recirculation by means of convection, on account of the temperature differences in the sorbent or the sorbent/refrigerant mixture.

It is possible to supply heat, for example, by transferring heat from at least part of the cleaning liquid which is heated in the machine process, for example a washing liquor in a dishwasher, to the sorbent by means of a heating coil or a heat exchanger. The use of an electrical heating coil in the form of an immersion heater is likewise possible without problems, as is heating by means of the container wall of the sorption container.

Other options for utilizing waste heat are also provided in addition to air cooling as in the prior art. Therefore, the sorbent or the sorbent/refrigerant mixture can, for example, be recirculated by means of a heat exchanger and/or by heating coils or flow heaters for the washing liquor or else for fresh water which is to be heated.

The refrigerant used in this case is preferably a substance which is soluble in liquid sorbent and can be completely or partially separated from the sorbent by the application of heat. As a result, a compressor, which is present in many refrigeration systems, or other pumps are superfluous.

In this case, a distillation column is preferably provided for concentration purposes or, in the ideal case, for substantially completely separating the refrigerant from the sorbent. A separation column of this type can be used to concentrate, in steps, a gas mixture which is expelled from the sorbent/refrigerant in gaseous form by heat being supplied, so that a gas mixture with a highly enriched content of refrigerant or, in the ideal case, the refrigerant in pure form is present at the output of a column of this type.

Furthermore, the distillation column is advantageously followed by a condensation apparatus for the expelled coolant, in order to condense this coolant from the gas phase to the liquid phase. To this end, a cooling device is preferably provided which, in a particularly advantageous embodiment, is cooled by fresh water which is required during operation of the domestic appliance in any case. The fresh water is preheated by this process, so that the thermal energy introduced for the distillation process in the gas phase is immediately available again as process heat.

Furthermore, a collection container is preferably provided for the expelled coolant in liquid form. As a result, a kind of cold store which can be activated at a later time can be realized.

In order to delay the cooling process until a later time, a shut-off valve is preferably provided in the connection line between the refrigerant container and the sorption container which contains the sorbent or the sorbent/refrigerant mixture. As long as this shut-off valve is closed, the separated and condensed coolant remains in the form of a cold store.

After expulsion of the refrigerant, the sorbent or the sorbent/refrigerant mixture in the sorption container is cooled down in an advantageous embodiment. In this case, the waste heat of the sorbent or of the sorbent/refrigerant mixture can again be used as process heat, for example for a washing liquor or for heating up fresh water. In the case of a liquid sorbent or sorbent/refrigerant mixture, it is possible to recirculate this sorbent or sorbent/refrigerant mixture by means of a heat exchanger and thus, for example, to heat the sump of a dishwasher or else fresh water by means of a heating coil or a flow heater or other heat exchangers.

To this end, in a particular development of the invention, a fresh-water tank is provided which can accommodate a sufficient quantity of fresh water in order to absorb the waste heat produced by the cooling unit, as far as possible largely for reuse.

In addition, the waste heat of the optionally provided distillation column can also be at least partially reused as process heat. To this end, a heat exchanger is preferably provided in order to heat the corresponding process fluid which absorbs the waste heat as process heat.

After the sorbent or sorbent/refrigerant mixture which has a depleted content of refrigerant is cooled down, the cooling process can be started by opening the connection valve between the refrigerant container and the sorbent container. In the process, the refrigerant evaporates and cools its surrounding area. The evaporated coolant then dissolves in the sorbent which heats up due to the heat of sorption. This heat of the sorbent which is enriched with refrigerant can in turn be used as process heat.

Direct air cooling is, in principle, possible in this case, for example for drying articles to be dried, for example in order to reheat a cold-air stream, which is cooled on the evaporator, using the heat of sorption. However, when using a liquid sorbent or sorbent/refrigerant mixture, it is particularly advantageous for the said sorbent or sorbent/refrigerant mixture to be recirculated by means of a cooler or heat exchanger with a large surface, so that good heat transfer to the air flowing through is possible. Coolers of this type, for example in finned form, are commercially available in high numbers for an extremely wide variety of technical applications.

The cold, evaporated or evaporating refrigerant can also be conducted by means of a heat exchanger or cooler across which the moist air from the chamber which contains the articles to be dried, for example a washing container, can be passed. The moisture from this moist air condenses during this cooling process and can be discharged. The dry cold air can, for example as described above, be reheated in order to improve drying.

Since a condensate of this type is distilled water, this condensate can also be used for fresh-water conditioning. In this way, the regeneration processes of an ion exchanger can optionally be performed with long time intervals and/or the ion exchanger of the domestic appliance can be smaller. This always results in a reduction in salt consumption.

When the condensate is reused in the process of the domestic appliance as the water recovered by condensation, the water consumption of the domestic appliance is reduced, with or without fresh-water conditioning.

It is possible to condition the fresh water without problems, particularly in combination with a fresh-water reservoir tank, as cited above.

After the cooling process, the refrigerant is again dissolved in the sorbent and is therefore available for a new working cycle.

It can be seen that, in principle, a separate pump for the refrigerant cycle is not required in this cooling apparatus. In order to transfer heat from the sorbent or sorbent/refrigerant mixture to the washing liquor, it is possible to use, for example, the recirculation pump for the washing liquor of a dishwasher by this washing liquor being conducted through a cooling coil located in the sorption container.

For the purpose of heat transfer to the fresh water both for cooling the expelled refrigerant and also for utilization of the waste heat of the sorbent or of the sorbent/refrigerant mixture, a second fresh-water container can be provided for example, so that fresh-water flow can be achieved by means of gravity.

However, in principle, the fresh-water inflow can also be directly conducted across corresponding heat-exchanger elements, so that the fresh water entering the fresh-water reservoir tank has already run through all the required heating stages.

The sorbent which is enriched with refrigerant for the purpose of desorption can also be heated, for example, with the aid of a heating system, which is present in the domestic appliance in any case, for a working fluid, for example for a washing liquor. The working liquid can be entirely or partially preheated by the heating apparatus of the domestic appliance and the heat can be transferred to the liquid sorbent/refrigerant mixture by means of a heating coil or a heat exchanger. This heating process using the heating apparatus which is present in any case is also entirely possible with fresh water which may already have been preheated.

The refrigerant used may be, for example, ammonia, which is already used in so-called absorption refrigeration appliances in conjunction with water as a sorbent. The system of water as refrigerant in a lithium bromide solution which is likewise known for this purpose can also be used according to the invention. These and further refrigerants and sorption materials can readily be used within the scope of the invention, even in combinations of several mixtures of material.

The cooling unit according to the invention can be advantageously used primarily where the requirement for cold can occur at a different time to that at which heat is applied to the sorbent, since a cold reservoir is cyclically stored in the form of a specific volume of condensed refrigerant. In addition to the described drying processes, use is also feasible, inter alia, in beverage machines in which beverages which are prepared hot are subsequently cooled, for example in coffee or espresso machines for preparing “cold coffee”.

In principle, the invention can advantageously be used in domestic appliances, with cooling cold for cooling operating media and/or articles being, in particular spontaneously or indirectly and/or briefly, required or requested or called up from a cold store or the cooling unit. This may be of particular advantage both in the applications already mentioned above and also, for example, for rapidly cooling bottles of wine, medicinal cool packs etc. in refrigerators or the like.

In all cases, it is important for a liquid sorbent to be used, in order to make use of the resulting structural freedom for utilizing waste heat of the sorbent or of the mixture of sorbent and refrigerant.

Various exemplary embodiments of the invention are explained in greater detail below and illustrated in the drawing in which, in detail,

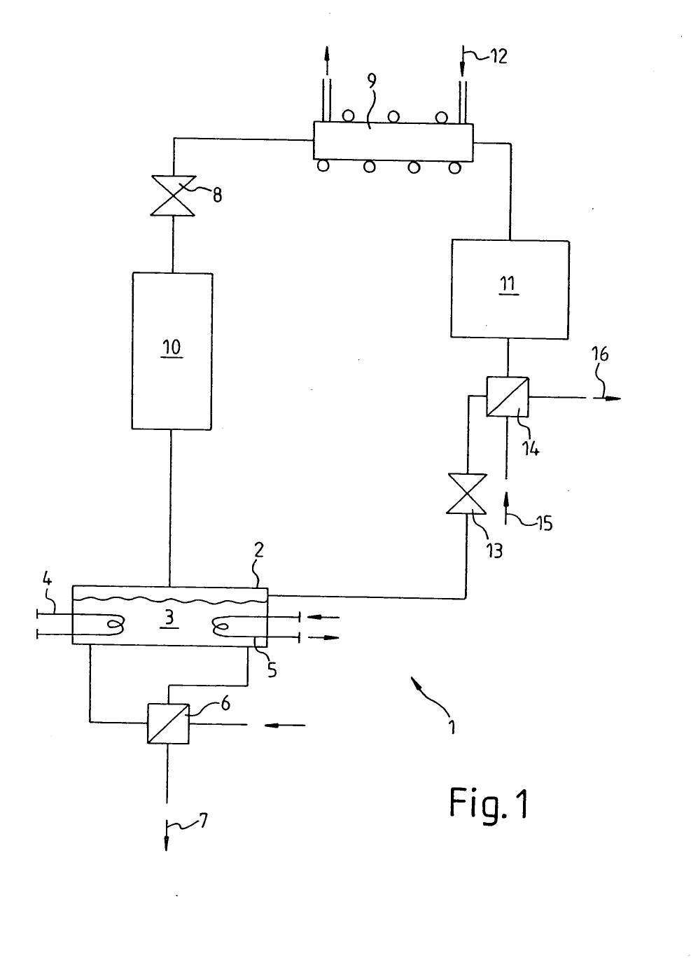

FIG. 1 shows a schematic block diagram of a cooling apparatus of a domestic appliance according to the invention,

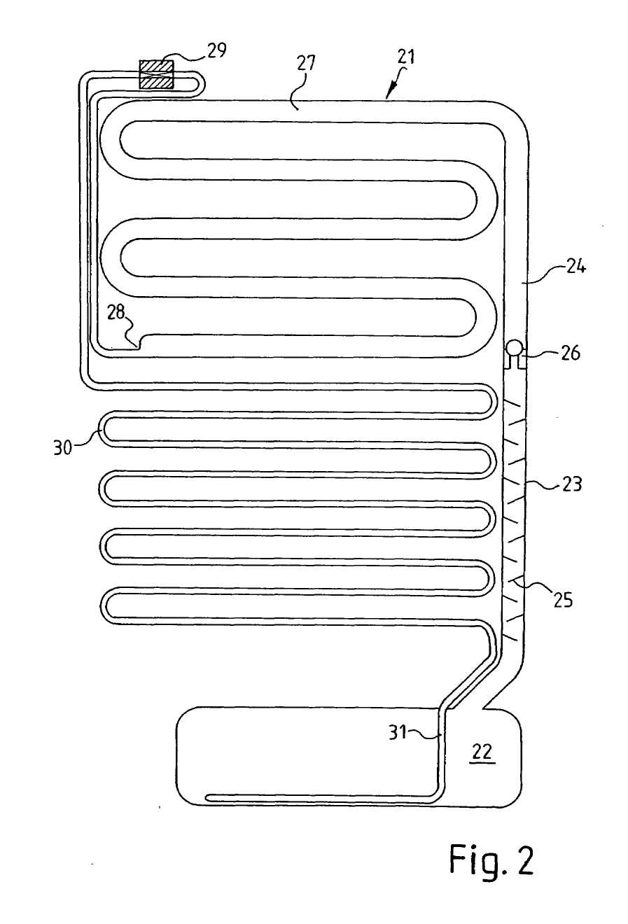

FIG. 2 shows a schematic diagram of a second embodiment variant of a cooling apparatus according to the invention, and

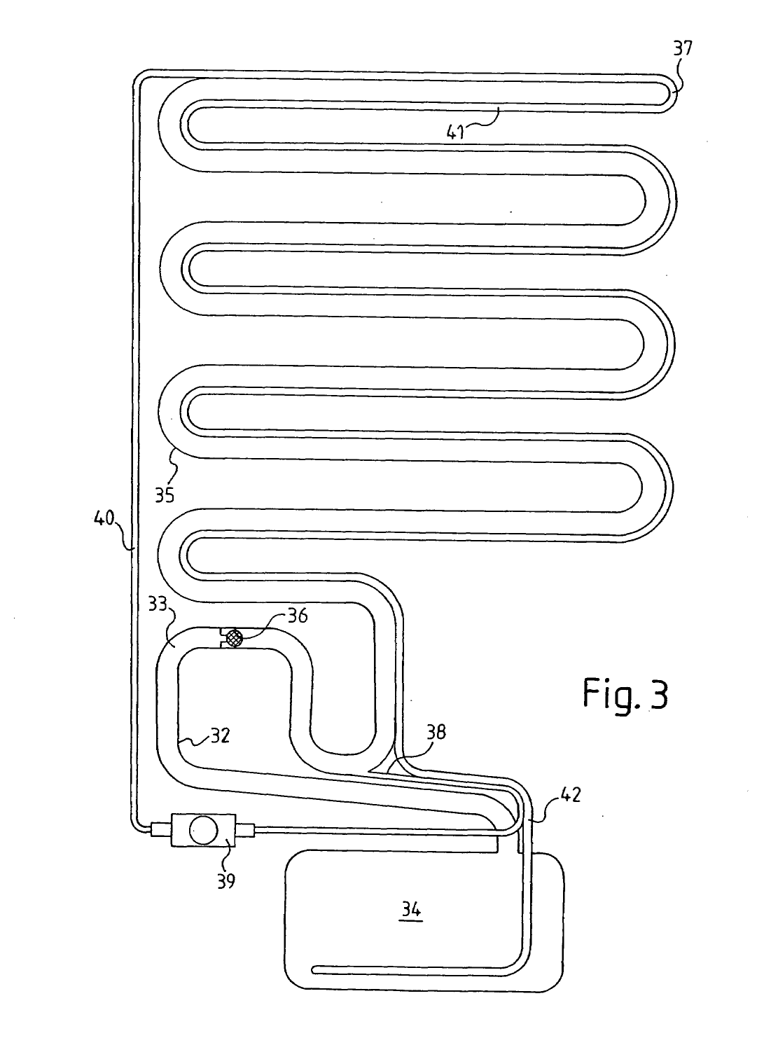

FIG. 3 shows a schematic diagram of a third embodiment variant.

The cooling apparatus 1 according to the figure comprises a sorption container 2 in which a mixture 3 of sorbent and refrigerant is filled in liquid form.

Heat can be supplied to this mixture of sorbent and refrigerant in order to cause the refrigerant to desorb. In the present diagram, three different ways of supplying heat are illustrated by way of example.

For example, it is possible to heat the sorbent/refrigerant mixture 3 by means of an electrical heating coil 4 which protrudes into the liquid in the sorption container 2 in the manner of an immersion heater. In this case, the heating coil 4 can heat the sorbent/refrigerant mixture only locally but, on account of the liquid property, uniform heat distribution is nevertheless provided due to convection. Heat distribution can optionally be assisted by stirring or pumping elements.

Another potential way of supplying heat is a fluid tube coil 5 which, in principle, is designed like the electrical heating coil 4 but comprises a hollow tube, so that a hot fluid, for example a working fluid from operation of the domestic appliance, can be supplied in a heated state, so that the sorbent/refrigerant mixture 3 is heated in this way. On account of heating of this kind, it is possible to use the process heat from operation of the domestic appliance for operation of the refrigeration unit.

A third heating alternative is provided by means of an external heat exchanger 6 by means of which the liquid sorbent/refrigerant mixture is recirculated. On account of the heat exchanger 6, a working fluid 7 can again be used for supplying heat. A working fluid 7 of this type is indicated by an arrow. In this case, a heating medium which is provided solely for this purpose can be used in conjunction with the heat exchanger 6 in order to heat the sorbent/refrigerant mixture.

All the described heating variants can be used as alternatives or in combination, at the same time or in sequence, and therefore provide a variety of ways of utilizing the process heat of the domestic appliance during operation.

When the sorbent/refrigerant mixture is heated, either refrigerant or a highly concentrated mixture of sorbent and refrigerant, depending on the materials selected, is evaporated and enters a cooler 9 via a shut-off valve 8. A distillation column 10 can optionally be interposed in order to concentrate a sorbent/refrigerant mixture, which is expelled from the sorption container 2, in steps.

Therefore, either refrigerant in pure form or a sorbent/refrigerant mixture with a high concentration of refrigerant enters the cooler 9. On account of the cooling, condensation is initiated in the cooler 9, so that the concentrated mixture or the pure refrigerant can be collected in a refrigerant container 11 in liquid form. A cooling fluid 12 which, for example, is suitable for further utilizing the waste heat, can be used to cool the cooler 9. Instead of this, fresh water, for example, can be used in order to utilize the heat of desorption which is drawn during the cooling process in order to preheat the cooling water.

The refrigerant container 11 can be separated from the sorbent container 2 by means of a further shut-off valve 13, so that the refrigerant which is present in liquid form in the refrigerant container 11 can be stored as a cold store when the shut-off valve 13 is closed.

The sorbent or the mixture, which has a depleted content of refrigerant, of sorbent and refrigerant 3 in the sorbent container 2 can be cooled in this working step, it being possible to effect this, for example, once again by using the heat exchanger 6 in conjunction with a cooling fluid. On account of the liquid form of the sorbent or of the sorbent/refrigerant mixture, this sorbent or sorbent/refrigerant mixture can also be recirculated for cooling by means of a heat exchanger 6 or a cooler. However, a cooling fluid can also be recirculated for cooling purposes by means of a cooling coil which protrudes into the sorption container 2, or can be used across the container wall of the sorption container 2. In this case, the cooling coil used may be, for example, the fluid tube coil 5 which was previously used as a heating coil.

Furthermore, a further heat exchanger 14 is illustrated between the refrigerant container 11 and the sorption container 2, the said heat exchanger forming the cooling unit and, for example, possibly being in the form of a cooler for a hot-air stream 15 when the shut-off valve 13 is open. The hot air 15 can be drawn, for example, from the interior of a domestic appliance in a suitable manner, for example by means of a fan, and conducted by means of the heat exchanger 14 which is used as a cooler. The resulting condensate can be discharged, or, as indicated further above, be used for fresh-water conditioning or simply to supplement the processing-water requirement. The dry cold-air stream 16 can optionally be heated again using the heat of sorption generated during dissolution of the refrigerant in the sorbent 3. Therefore, the cold-air stream 16 can be conducted, for example via the fluid tube coil 5 and/or the heat exchanger 6, so that said cold-air stream is reheated using the heat of sorption. This heated dry air stream is most highly suited to drying wet, cleaned articles, for example washware in a dishwasher.

It goes without saying that other heat exchangers, which operate independently of one another, can also be provided for the different fluid streams, in order to make use of the waste heat, which is produced in individual method steps, from the cooling unit 1 or in order to use process heat from operation of the domestic appliance for the cooling unit 1.

Furthermore, all the above-described ways of discharging waste heat or supplying process heat in conjunction with the sorbent/refrigerant mixture 3 in the sorption container 2 can also be used in the region of the distillation column 10.

The embodiment variant according to FIG. 2 corresponds substantially to the abovementioned exemplary embodiment, but its structure is considerably simplified. This design is distinguished particularly in that it can be very flat, so it can be fitted to a side wall of the working chamber of a domestic appliance.

The cooling apparatus 21 according to FIG. 2 comprises, like the abovementioned exemplary embodiment, a sorption container 22 which, depending on the operating state, contains a sorbent/refrigerant mixture in an enriched or depleted state.

The sorbent/refrigerant mixture contained in the sorption container 22 can be heated by heating means (not illustrated in any detail). As a result, the refrigerant can evaporate and escape into the rectification region 23 of a tube line 24. In the present embodiment, the rectification region 23 is provided with baffles 25 on which co-evaporated sorbent can condense and flow back, so that separation of sorbent and refrigerant in the rectification region 23 is improved. The rectification region 23 accordingly corresponds, in terms of function, to the distillation column 10 of the above-described exemplary embodiment.

A non-return valve 26 separates the rectification region 23 from the following condensation unit 27 which is in the form of a subregion of the tube line 24. The condensation unit is of serpentine construction and is provided with a cross-sectionally tapered portion 28 in its end region. A switchover valve 29 limits the condensation unit 27 and interrupts the connection between the said condensation unit and the sorption container 22 in the direction of flow of the refrigerant. The tube line 24 accordingly forms the refrigerant container, which is present in the abovementioned exemplary embodiment, between the non-return valve 26 and the switchover valve 29. In the illustrated exemplary embodiment, the refrigerant is condensed by heat being dispensed to the surrounding area without active cooling. However, active cooling can be readily provided in this region, for example by fresh water, if required.

The switchover valve 29 is followed by a cooling unit 30 in the form of a subsection of the tube line 24 which is arranged substantially beneath the condensation region and is likewise of serpentine form. The tube line 24 ends by way of an end piece 31 downstream of the evaporator region 30 in the sorption container 22. The cooling unit is cooled by evaporated or cold, pre-evaporated refrigerant and can dispense the cold thus produced.

This embodiment variant is structurally already considerably simplified compared to the first exemplary embodiment. All circulation of the refrigerant takes place in a single tube line. In order to operate this cooling apparatus 21, it is necessary to perform only two control operations which can be decoupled from one another in terms of time. In first instance, it is necessary to heat the refrigerant/sorption mixture in the sorption container 22 in order to expel the refrigerant. Condensed refrigerant is then available in the condensation unit 27 in the form of a cold store. The switchover valve 29 can be opened at the desired time, in a manner decoupled in terms of time from the heating process, so that the refrigerant can escape in the direction of the sorption container 22 and in the process can be used, with evaporation, for cooling purposes in the cooling unit 30.

This embodiment variant is accordingly highly simplified compared to the first exemplary embodiment not only in terms of the structural design, but also in terms of the outlay on control.

The embodiment variant according to FIG. 3 again has a rectification region 32 of a tube line 33 which branches off from a sorption container 34. The rectification region 32 again merges with a condensation unit 35, which is in the form of a tube line and is again of serpentine construction, via a non-return valve 36.

In a departure from the abovementioned exemplary embodiment, the condensation unit 35 ends in the form of a blind passage at its upper end 37. In this embodiment, the condensation unit 35 is accordingly filled from below, that is to say pre-condensed refrigerant assists the condensation process as gaseous refrigerant which is expelled from the sorption container 34 by heating means (not illustrated in any detail) passes through.

A cooling line 38, which issues into a riser line 40 via a switchover valve 39, branches off in the lower region, that is to say at the lowest point of the condensation unit 35 in the illustrated embodiment. The riser line 40 is already part of a cooling unit 41 which is tubular and in which the refrigerant evaporates. The cooling unit 41 nestles against the serpentine condensation unit 35. The said cooling unit issues into an outflow line 42 in the sorption container 34. This embodiment variant can again be of very flat and at the same time comparatively low construction. The branching-off cooling line 38 with a reduced cross section is now provided in place of the cross-sectionally tapered portion 28.

In this embodiment variant, the evaporation process is assisted by liquid refrigerant being forced into the riser line 40 of the cooling unit 41 under the action of gravity. By virtue of the resulting cooling effect of the condensation unit 35 on account of the thermal contact between the cooling unit 41 and the condensation unit 35, any other gaseous residues of refrigerant are condensed out in the upper region of the condensation unit 35 at the same time. Therefore, the condensation unit 35 is virtually completely emptied, as a result of which the existing refrigerant is utilized highly efficiently.

The embodiment variant according to FIG. 3 can accordingly be implemented to be even more compact than the embodiment variant according to FIG. 2 with a comparable cooling power. Both cases involve a substantially closed tube system, so that the requirements for leak-tightness can be easily fulfilled.

The embodiment variant according to FIG. 3 makes use of the situation that, in a cooling apparatus according to the invention, the time at which the refrigerant is expelled from the sorption container 34 by heating is decoupled from the time of the desired cooling. The variant according to FIG. 3 accordingly does not exhibit a closed circuit comprising a rectification region, condensation unit and cooling unit. Instead, the temporal decoupling between application of heat and cooling is utilized to the effect that it is possible to reverse the direction of flow in the condensation unit 35. Filling of the condensation unit 35 when refrigerant is expelled from the sorbent is accordingly performed in the opposite direction to emptying into the cooling unit.

The inventive separation of cooling unit and condensation unit by the interposed refrigerant-carrying connection is important in all the embodiments of the invention.

### LIST OF REFERENCE SYMBOLS

1 Cooling apparatus

2 Sorption container

3 Sorbent/refrigerant

4 Heating coil

5 Fluid tube coil

6 Heat exchanger

7 Heating fluid

8 Shut-off valve

9 Cooler

10 Distillation column

11 Refrigerant container

12 Cooling fluid

13 Shut-off valve

14 Heat exchanger

15 Hot air

16 Cold-air stream

21 Cooling apparatus

22 Sorption container

23 Rectification region

24 Tube line

25 Baffle

26 Non-return valve

27 Condensation unit

28 Cross-sectionally tapered portion

29 Switchover valve

30 Cooling unit

31 End piece

32 Rectification region

33 Tube line

34 Sorption container

35 Condensation unit

36 Non-return valve

37 End

38 Cooling line

39 Switchover valve

40 Riser line

41 Cooling unit

42 Outflow line

What is claimed is:

1. Domestic appliance having a cooling apparatus, with the heat provided for the cooling unit being utilized as process heat during working operation of the domestic appliance, characterized in that a liquid sorbent and/or a liquid sorbent/refrigerant mixture is provided.

2. Domestic appliance according to claim 1, characterized in that a heating means is provided for expelling refrigerant from a sorbent/refrigerant mixture.

3. Domestic appliance according to either of the preceding claims, characterized in that a distillation column is provided.

4. Domestic appliance according to one of the preceding claims, characterized in that a cooler is provided for condensing the gaseous refrigerant and/or gaseous sorbent/refrigerant mixture.

5. Domestic appliance according to one of the preceding claims, characterized in that a heat exchanger is provided for transferring heat between the liquid sorbent or liquid sorbent/refrigerant mixture and dry, cool air.

6. Domestic appliance according to one of the preceding claims, characterized in that a heat exchanger is provided between a working fluid of the domestic appliance and the liquid sorbent or liquid sorbent/refrigerant mixture.

7. Domestic appliance according to one of the preceding claims, characterized in that a heat exchanger is provided between the supplied fresh water and the refrigerant or sorbent/refrigerant mixture.

8. Domestic appliance according to one of the preceding claims, characterized in that a heat exchanger is provided between the fresh water and the liquid sorbent or liquid sorbent/refrigerant mixture.

9. Domestic appliance according to one of the preceding claims, characterized in that a reservoir container for fresh water is provided.

10. Domestic appliance according to one of the preceding claims, characterized in that the refrigerant is ammonia and the sorbent is water.

11. Domestic appliance according to one of the preceding claims, characterized in that the refrigerant is water and the sorbent is a water/lithium bromide solution.

12. Domestic appliance according to one of the preceding claims, characterized in that the cooling unit is provided for drying wet articles by condensation.

13. Method for drying wet, cleaned articles in a domestic appliance in a working chamber of the domestic appliance, with the air surrounding the articles being dried on a cooled surface by condensation, characterized in that a liquid sorbent and/or a liquid refrigerant/sorbent mixture is used.

14. Method according to claim 12, characterized in that the heat of condensation of the refrigerant is used to heat a working fluid of the domestic appliance.

15. Method according to either of claims 12 and 13, characterized in that the heat of condensation of the refrigerant is used to heat fresh water.

16. Method according to one of claims 12 to 14, characterized in that the residual heat of the supplied heat of desorption and/or the produced heat of sorption of the sorbent or of the sorbent/refrigerant mixture is used to heat a working fluid of the domestic appliance.

17. Method according to one of the preceding claims, characterized in that the residual heat of the supplied heat of desorption and/or the produced heat of sorption from the sorbent and/or a sorbent/refrigerant mixture is used to heat fresh water.

18. Dishwasher, characterized in that it is in the form of an appliance according to one of claims 1 to 12.

19. Washing machine, characterized in that it is in the form of an appliance according to one of claims 1 to 12.

20. Tumble dryer, characterized in that it is in the form of an appliance according to one of claims 1 to 12.

21. Beverage machine, in particular espresso machine, characterized in that it is in the form of an appliance according to one of claims 1 to 12.
